(19) United States
(12) Patent Application Publication
(10) Pub. No.: US 2006/0103672 A1
(43) Pub. Date: May 18, 2006

(54) System, method, and computer program product for managing parametric and other objects

(75) Inventor: Timothy L. Gilbert, Polk City, IA (US)

Correspondence Address: DOCKET CLERK, PO BOX 800889, DALLAS, TX, 75380, US

(73) Assignee: UGS Corp., Plano, TX (US)

(21) Appl. No.: 10/988,169

(22) Filed: Nov. 12, 2004

(51) Int. Cl. G09G 5/00

(52) U.S. Cl. 345/629

(57) ABSTRACT

An XML system and format for managing multiple parametric objects. The preferred embodiments allow users to model complex systems of discrete parametric objects. Complex equipment systems such as overhead conveyors or automated guided vehicles can be modeled using a simple center-line path and a library of parametric XML objects. Properties may be specified for each XML object or common values may be applied to the entire system.

### TECHNICAL FIELD OF THE INVENTION

The present invention is directed, in general, to object modeling.

### BACKGROUND OF THE INVENTION

In current computer-aided design (CAD) packages, customers are able to design their own parametric objects, using AutoCAD or similar packages. While parametric objects provide a versatile solution for modeling discrete objects, they are not capable of efficiently modeling complex relationships. Discrete object modeling has been determined to be a significant weakness in the product. We realized that our customers needed a way to define the relationships between parametric objects.

There is, therefore, a need in the art for a system, process and method for defining the relationships between parametric objects.

### SUMMARY OF THE INVENTION

The preferred embodiment provides an XML format designed to manage multiple parametric objects. The preferred embodiments allow users to model complex systems of discrete parametric objects. Complex equipment systems such as overhead conveyors or automated guided vehicles can be modeled using a simple center-line path and a library of parametric XML objects. Properties may be specified for each XML object or common values may be applied to the entire system.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a block diagram of a data processing system in which a preferred embodiment can be implemented;

FIG. 2 depicts an exemplary series of XML objects;

FIG. 3 depicts an XML object in accordance with an embodiment of the present invention; and

FIG. 4 depicts a flowchart of a process in accordance with a preferred embodiment.

### DETAILED DESCRIPTION OF THE INVENTION

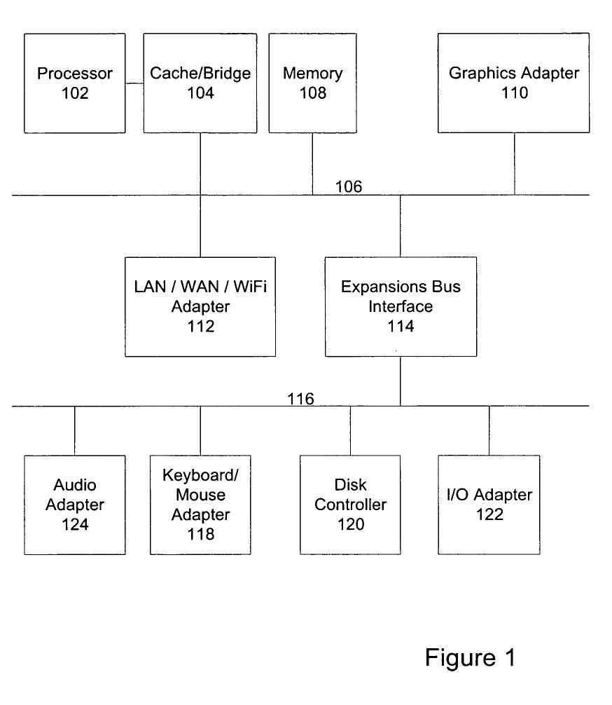

FIGS. 1 through 4, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

FIG. 1 depicts a block diagram of a data processing system in which a preferred embodiment can be implemented. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular. For example, other peripheral devices, such as an optical disk drive and the like, also may be used in addition or in place of the hardware depicted. The depicted example is provided for the purpose of explanation only and is not meant to imply architectural limitations with respect to the present invention.

A data processing system in accordance with a preferred embodiment of the present invention includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present invention as described.

Many users need to model complicated systems of objects, but discrete parametric objects do not provide the ability to share common parameters or define spatial relationships. The preferred embodiment provides an XML format designed to manage multiple parametric objects. The preferred embodiments allow users to model complex systems of discrete parametric objects. Complex equipment systems such as overhead conveyors or automated guided vehicles can be modeled using a simple center-line path and a library of parametric XML objects. Properties may be specified for each XML object or common values may be applied to the entire system.

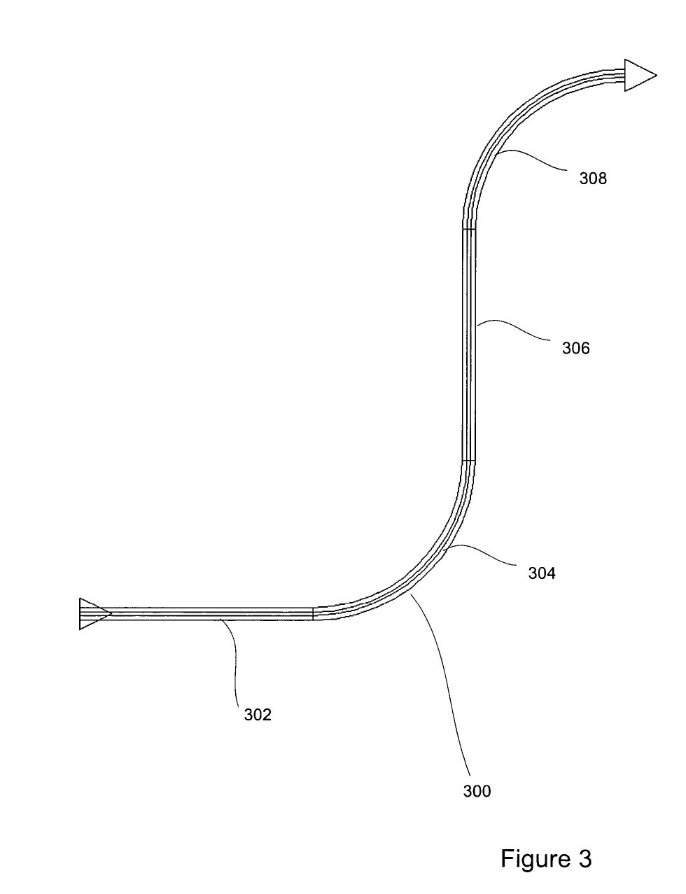

The XML system, in a preferred embodiment, manages a collection of parametric XML objects as a single system, as illustrated in FIG. 3, below. The XML system includes a node graph object that contains one or more node objects. Each node object is a fully parametric XML object. The system manages the relationships between node objects in the node graph and exposes the parameters and user interface (UI) for each node object. The node graph contains an array of node objects and a node graph manager object. The graph manager object provides the internal interface to the node array. This includes filing, cloning, accessing parameters, and applying transformations to each node object in the array.

An XML system, in accordance with a preferred embodiment, consists of five major parts: a group of XML objects, an XML node graph array, a command and instructions to assemble discrete XML objects, an interface to interactively specify object relationships, and commands/instructions to modify the properties of individual objects or common properties of all objects in the system.

An XML object, according to the disclosed embodiments, is a parametric object consisting of geometry, controls, and equations. The relationships and behavior are modeled in an XML graph. FACTORY CAD is an example of a commercial software product that uses XML objects, and provides a program called XML Object Toolkit for designing custom XML objects. XML objects model equipment shape, placement, reach, potential interference, and safety envelope. As discrete objects, they have limited interaction with other objects.

An XML node graph array, according to the disclosed embodiments, is an object that manages a collection of XML graphs. The node graph array exposes the specified functionality of the individual graphs while providing a single identity for global modifications. The relationships between the graphs are maintained by internal connections between nodes.

For example, if node one has a piece of geometry that is 12 inches long, and node two is placed at the end of that geometry, a connection may be established so that modifying the length of the piece in node one to 24 inches will displace node two by 12 inches. The node graph array has ownership of the individual graphs and is responsible for filing each graph. The node graph array allows individual graphs to be modified through their specified dialog interface or dynamically through the exposed “grip” controls.

The command to assemble a system allows the user to specify any combination of existing XML objects or systems to add to a new XML node graph array. First, the customer will need to insert two or more XML objects into an active drawing file, establishing their relative position and optionally creating external connections to each other. The user will then use the assemble system command to create an XML system object by inserting each XML object into the system node graph array. This command will remove the discrete XML objects and replace them with a single XML system. This new system contains an XML node graph array that contains the graph array of each of the original XML objects. Common external connections will become internal connections to the XML system.

In the preferred embodiment, there is also an interface to interactively specify the discrete XML objects to be included in the XML system. This method allows the user to specify the types, properties, and locations of the discrete XML objects to be included in the system.

In one embodiment, an interface allows the interactive specification of sequential XML objects. This command allows the user to identify a group of related XML objects that will be laid out by a series of point selections.

An example would be a set of XML objects that represent the various sections of a conveyor system. These might include straight, curve, and incline sections of conveyor. The sequential interface creates the XML objects and adds them to the system based on a series of points selected by the user. The appropriate controls in the XML objects will be modified based on the distance and angle between the selected points. As two points are selected, the straight section of conveyor will be created and the value of the length control will be set to the distance between the two points. The interface will then query the straight section for its actual length and adjust the next point as needed. If a third point is designated that is not collinear with the first two points, the interface will create a curved section and position it appropriately. The angle of the curved section will be set to the angle designated. The interface will then query the curved section for its actual angle and adjust the next point as needed. Future development plans include interfaces for other common arrangements such as machine assemblies or rectangular and polar arrays.

The XML system preferably also provides an interface to globally apply parameters to every object in the system. For example, the width parameter of a conveyor system may be changed for every XML object by simply changing the property at the system level. The XML system will also allow the user to perform system level calculations based on the collective properties of the XML objects in the node graph. An example would be the total horsepower required for a system of conveyor objects.

Further, commands are included to modify the XML control values. The command to modify an individual XML graph will prompt the user to select the part of the system to modify. Then the command will present a dialog box of the graphs exposed XML controls and update the individual XML graph with the new values. Only the control values in the selected graph will be changed. Other graphs in the system may be relocated based on the internal connections.

The command to modify the system properties will prompt the user to select a system. The command will present a dialog box of all the exposed XML controls in each graph. Changes to control values will be reflected in each graph of the system that contains a control with the same name.

The use of XML as the data exchange format makes it easier for our product to integrate with other products. For instance, by exporting the XML data other applications could query the data tree for information on the relationships and parameters of the system nodes. The XML system relationships can be used to track product or process flow.

By modeling the relationships between parametric XML models, the XML system provides a new method for representing complex systems. An XML system allows discrete XML objects to be manipulated as a single entity while maintaining discrete properties. Additionally, changes may be made to exposed properties at the system level and propagated to each XML graph in the array.

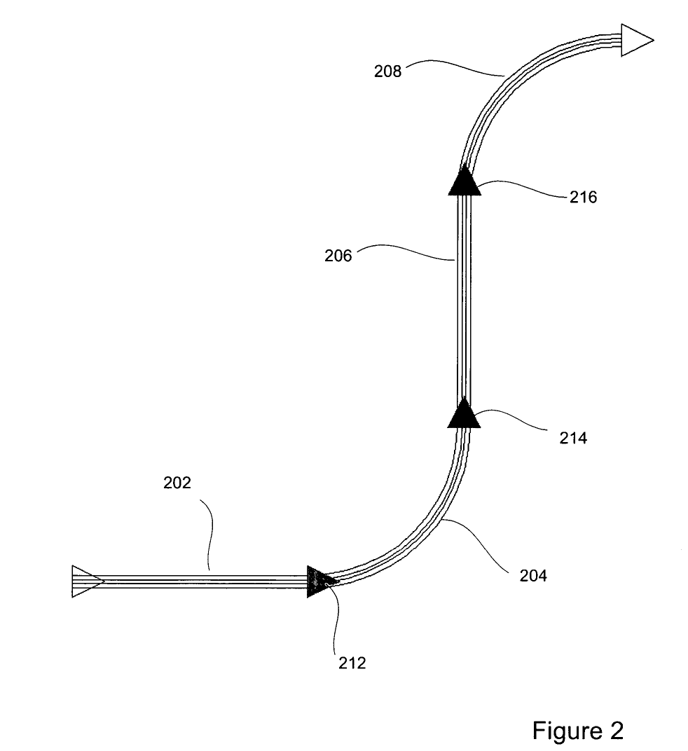

FIG. 2 depicts a series of four XML objects 202/204/206/208. Arrows 212/214/216 represent external connector objects. They are required to maintain the relationships between the individual pieces. The system uses four object IDs for the equipment and eight object IDs for the external connectors.

FIG. 3 depicts four XML objects 302/304/206/208, corresponding to objects 202/204/206/208, after they have been assembled into a single XML system 300. The closed external connectors shown in FIG. 2 have been replaced by internal connections. The single system object requires less memory space in the drawing file. It uses a single object ID for the system and two object IDs for the remaining external connectors.

A system is constructed by creating one or more XML objects and adding them to the new system object. The contents of each XML object will be cloned and added to the system's node graph object. Objects added to the system may have an established relationship based on their connector sensors. If this is the case, the appropriate internal connections are mapped so the graph manager can maintain the relationship. When a property in one graph causes a sensor to relocate, the graph manager will transform the graph associated with the matching sensor to the correct location and direction.

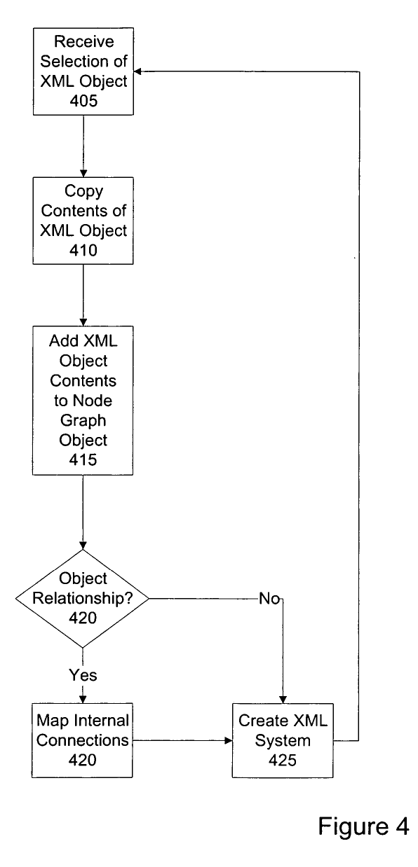

FIG. 4 depicts a flowchart of a process in accordance with a preferred embodiment, for creating an XML system using a data processing system. First, the data processing system will receive a user selection of at least one XML object (step 405). Next, the contents of the XML object will be copied (step 410) and added to the XML system node graph object (step 415). Of course, if this is the first XML object to be added to the XML system, the XML system node graph object can be created to store the copy of the contents of the XML object.

The data processing system will determine if the added object has an established relationship with another object (step 420), and if so, will map the corresponding internal connections (step 425). The data processing system will then produce an XML system comprised of the selected XML objects (step 430), or expand an existing XML system, repeating as necessary to step 405 if additional XML objects are selected.

Those skilled in the art will recognize that, for simplicity and clarity, the full structure and operation of all data processing systems suitable for use with the present invention is not being depicted or described herein. Instead, only so much of a data processing system as is unique to the present invention or necessary for an understanding of the present invention is depicted and described. The remainder of the construction and operation of data processing system 100 may conform to any of the various current implementations and practices known in the art.

It is important to note that while the present invention has been described in the context of a fully functional system, those skilled in the art will appreciate that at least portions of the mechanism of the present invention are capable of being distributed in the form of a instructions contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs), and transmission type mediums such as digital and analog communication links.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

What is claimed is:

1. A method for managing objects, comprising:
receiving a selection of at least one XML object, the XML object having associated object parameters;
copying the object parameters;
storing the object parameters in a node graph object; and
creating an XML system according to the XML object and the node graph object.

2. The method of claim 1, further comprising
determining if the at least one XML object has an established relationship with another XML object;
mapping the internal connections between the at least one XML object and the another XML object.

3. The method of claim 1, wherein the XML system comprises a plurality of XML objects, the XML node graph array, instructions for assembling discrete XML objects, instructions for interactively specifying XML object relationships, and instructions for modifying the properties of individual objects.

4. The method of claim 1, wherein the XML system comprises a plurality of XML objects and instructions for modifying any common properties of multiple XML objects.

5. The method of claim 1, wherein each of the at least one XML object is a fully parametric XML object.

6. The method of claim 1, wherein the XML system manages relationships between XML objects and exposes the parameters and a user interface for each XML object.

7. The method of claim 1, wherein the XML system comprises a node graph having an array of node graph objects and a node graph manager object.

8. The method of claim 7, wherein the node graph manager object provides an internal interface to array of node graph objects, including filing, cloning, accessing parameters, and applying transformations to each node graph object in the array of node graph objects.

9. A data processing system having at least a processor and accessible memory, comprising:
means for receiving a selection of at least one XML object, the XML object having associated object parameters;
means for copying the object parameters;
means for storing the object parameters in a node graph object; and
means for creating an XML system according to the XML object and the node graph object.

10. The data processing system of claim 9, further comprising
means for determining if the at least one XML object has an established relationship with another XML object;
means for mapping the internal connections between the at least one XML object and the another XML object.

11. The data processing system of claim 9, wherein the XML system comprises a plurality of XML objects, the XML node graph array, instructions for assembling discrete XML objects, instructions for interactively specifying XML object relationships, and instructions for modifying the properties of individual objects.

12. The data processing system of claim 9, wherein the XML system comprises a plurality of XML objects and instructions for modifying any common properties of multiple XML objects.

13. The data processing system of claim 9, wherein each of the at least one XML object is a fully parametric XML object.

14. The data processing system of claim 9, wherein the XML system manages relationships between XML objects and exposes the parameters and a user interface for each XML object.

15. The data processing system of claim 9, wherein the XML system comprises a node graph having an array of node graph objects and a node graph manager object.

16. The data processing system of claim 15, wherein the node graph manager object provides an internal interface to array of node graph objects, including filing, cloning, accessing parameters, and applying transformations to each node graph object in the array of node graph objects.

17. A computer program product tangibly embodied in a machine-readable medium, comprising:
instructions for receiving a selection of at least one XML object, the XML object having associated object parameters;
instructions for copying the object parameters;
instructions for storing the object parameters in a node graph object; and
instructions for creating an XML system according to the XML object and the node graph object.

18. The computer program product of claim 17, further comprising
instructions for determining if the at least one XML object has an established relationship with another XML object;
instructions for mapping the internal connections between the at least one XML object and the another XML object.

19. The computer program product of claim 17, wherein the XML system comprises a plurality of XML objects, the XML node graph array, instructions for assembling discrete XML objects, instructions for interactively specifying XML object relationships, and instructions for modifying the properties of individual objects.

20. The computer program product of claim 17, wherein the XML system comprises a plurality of XML objects and instructions for modifying any common properties of multiple XML objects.

21. The computer program product of claim 17, wherein each of the at least one XML object is a fully parametric XML object.

22. The computer program product of claim 17, wherein the XML system XML system manages relationships between XML objects exposes the parameters and a user interface for each XML object.

23. The computer program product of claim 17, wherein the XML system comprises a node graph having an array of node graph objects and a node graph manager object.

24. The computer program product of claim 23, wherein the node graph manager object provides an internal interface to array of node graph objects, including filing, cloning, accessing parameters, and applying transformations to each node graph object in the array of node graph objects.
